(19) United States
(12) Patent Application Publication
(10) Pub. No.: US 2026/0222663 A1
(43) Pub. Date: Jul. 30, 2026

(54) RECORDING DEVICE WITH A FRONT DISPLAY AND A TOP DISPLAY

(71) Applicant: Axon Enterprise, Inc., Scottsdale, AZ (US)

(72) Inventors: Arjun Subramanian, Seattle, WA (US); Craig G. Trudgeon, Bellingham, WA (US); Hans Moritz, Scottsdale, AZ (US); Elliot L. Ortiz, Pinole, CA (US); Mark J. Eastwood, Scottsdale, AZ (US); James Blake Bullock, Gilbert, AZ (US)

(21) Appl. No.: 19/353,229

(22) Filed: Oct. 8, 2025

Related U.S. Application Data
(60) Provisional application No. 63/751,818, filed on Jan. 30, 2025.

(51) Int. Cl. H04N 23/53; G06F 3/14; G06F 3/147

(52) U.S. Cl. CPC H04N 23/53; G06F 3/1423; G06F 3/147

(57) ABSTRACT

A recording device may comprise a body, a first display, and a second display. The body may comprise a front surface opposite a rear surface, a top surface opposite a bottom surface, and a first side surface opposite a second side surface. The first display may be disposed on the front surface. The first display may be configured to provide a first visual output. The second display may be disposed on the top surface. The second display may be configured to provide a second visual output. The first visual output may be different from the second visual output.

### FIELD OF INVENTION

Embodiments of the present disclosure relate to a recording device.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 is a diagram of a recording device at an incident, in accordance with various embodiments;

FIG. 2 is a block diagram of a recording device, in accordance with various embodiments;

FIG. 3A is a first front perspective view of a recording device, in accordance with various embodiments;

FIG. 3B is a second front perspective view of the recording device of FIG. 3A, in accordance with various embodiments;

FIG. 4 illustrates a process flow for a method of providing visual outputs on a first display and a second display of a recording device, in accordance with various embodiments; and

FIG. 5 is a block diagram illustrating components of a computer-based system, in accordance with various embodiments.

Elements and steps in the figures are illustrated for simplicity and clarity and have not necessarily been rendered according to any particular sequence. For example, steps that may be performed concurrently or in different order are illustrated in the figures to help to improve understanding of embodiments of the present disclosure.

### DETAILED DESCRIPTION

The detailed description of various embodiments refers to the accompanying drawings, which show various embodiments by way of illustration. While these various embodiments are described in sufficient detail to enable those skilled in the art to practice the disclosure, it should be understood that other embodiments may be realized, and that logical and physical changes may be made without departing from the spirit and scope of the disclosure. Thus, the detailed description is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Also, any reference to attached, fixed, coupled, connected, or the like may include permanent, removable, temporary, partial, full, and/or any other possible attachment option. Surface shading lines may be used throughout the figures to denote different parts but not necessarily to denote the same or different materials.

In various embodiments, an incident (or similar terms and phrases, such as an emergency) may refer to human or animal activities and to a period of time while these activities take place. Incidents may include, for example, formation of agreements, transactions, negotiations, discussions, ceremonies, meetings, medical procedures, sporting events, crimes, attempted crimes, disagreements, assaults, conflicts, discoveries, research, investigations, surveillance, and/or the like. Incidents may include consequences including changes to property such as improvements, repairs, construction, production, manufacture, growth, harvesting, damage, loss, theft, burglary, arson, goods damaged in shipment, conditions of real estate, conditions of agricultural and forestry property, and/or the like. An incident may include damage to property and/or injury to persons or animals. Damage to property or injury to persons or animals may be accidental or brought on by the action or failure to act of one or more persons. Incidents include information valuable for risk management, insurance, claims, achievements, sports records, news reporting, entertainment, and/or the like.

One or more incident responders may respond or help before, during, or after an incident. For example, in response to an incident including a fire (e.g., burning building, house fire, etc.), incident responders may include a law enforcement officer, a firefighter, a medical responder (e.g., an emergency medical technician (EMT), a paramedic, an ambulance technician, etc.). As a further example, in response to an incident including a crime or attempted crime, incident responders may include one or more law enforcement officers. As a further example, in response to an incident including a covert military operation, incident responders may include one or more military personnel. As a further example, in response to an incident involving a retail store, incident responders may include retail staff, private security, or the like. As a further example, in response to an incident involving a medical office, hospital, or the like, incident responders may include office staff, nurses, doctors, private security, or the like.

Information (e.g., data, audio, visual, location, environmental, etc.) gathered about an incident may describe the incident. Information may include facts about the activities of the incident, consequences of the incident, time of the incident, location of the incident, and identity of humans, animals, or objects related to the incident. Information about an incident may form a report of an incident (e.g., an incident report). Information about the incident may be gathered before, during, and/or after an incident. Incident information may be recorded (e.g., audio, video) to document an incident at the time of occurrence.

Recording incident information captures at least some of the information about the incident. Recording further protects against loss of information, for example, by physical loss or by faulty human memory. For example, incident responders may capture audio and/or visual information of the incident. The audio and/or visual information may be captured by a recording device, such as, for example, a body-worn camera, a smartphone, an internet of things (IoT) device, a vehicle-mounted camera, a surveillance camera, and/or any other recording device discussed herein. Recording the incident information may include storing the information in a memory of the recording device. Recording the incident information may include transmitting the information to a remote device, server, or the like.

Recording devices may capture incident information of a scene from a fixed position (e.g., a fixed field of view, a fixed vantage point, etc.). For example, a body-worn camera may capture a fixed field of view from the body of the incident responder, a vehicle-mounted camera may capture a fixed field of view from the vehicle, a hallway-mounted camera may capture a fixed position from the hallway, etc.

Recording devices may provide information to an incident responder via a display. For example, a body-worn camera may provide information to the person wearing the body-worn camera via a display, a vehicle-mounted camera may provide information to the person operating the vehicle via a display, etc. Information provided via the display to the incident responder may include data regarding the recording device. Information provided via the display to the incident responder may comprise wireless connectivity strength, remaining battery capacity, recording status, etc.

Recording devices may provide information to a person at an incident via a display. The person at the incident may include a person at the incident, other than the incident responder. For example, at an incident including a crime or an attempted crime, a recording device may provide information to a suspect via the display. The information may comprise non-video information. The information may be separate from video data captured by the recording device, if any. The information may comprise status information regarding an operating state of the recording device. The information may comprise configuration information regarding a setting of the recording device. For example, information provided via the display to a person at the incident may comprise a recording status, de-escalation progress, remaining time, etc. The information may comprise ownership information, such as an individual, a company, an authority, an affiliation, a sponsorship, an incident responder, and/or the like that owns or operates the recording device.

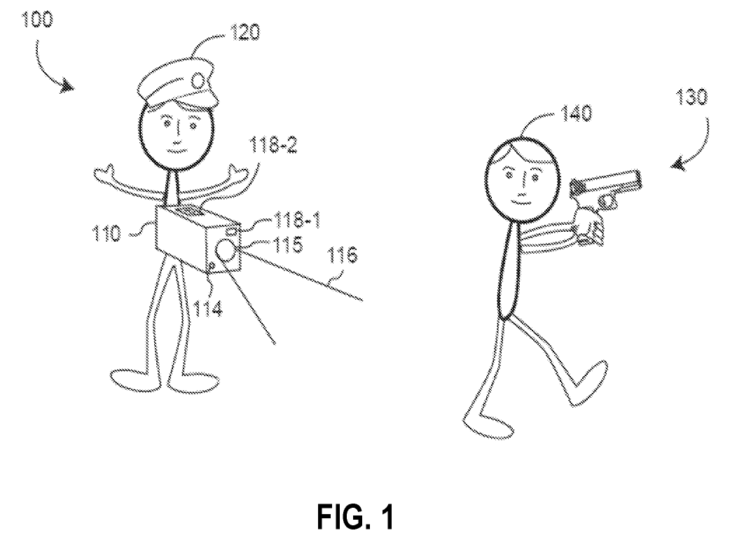

In various embodiments, and with reference to FIG. 1, a recording device at an incident is disclosed. The recording device may be configured to capture incident information from a fixed field of view. The recording device may be configured to be worn on by an incident responder (e.g., as a body-worn camera). The recording device may be oriented (e.g., pointed, aimed, etc.) toward a scene to record incident information to document the incident at the time of occurrence. In various embodiments, and as discussed further herein, the recording device may be configured to provide a plurality of displays, each display configured to provide information in different directions.

In various embodiments, and with reference to FIG. 1, a recording device 110 at an incident 100 is disclosed. Recording device 110 may be worn by an incident responder 120. Recording device 110 may comprise an optical element, such as a lens 115, that is aimed at a scene of interest, such as scene 130. Scene 130 may include a suspect, such as suspect 140. Recording device 110 may comprise a field of view (e.g., field of capture, etc.), such as field of view 116. Field of view 116 may correspond with a direction toward which lens 115 is aimed. For example, in accordance with lens 115 aimed toward scene 130, field of view 116 may comprise a portion of scene 130, such as a portion of, or all of, suspect 140.

In various embodiments, recording device 110 may comprise a display. A display may comprise a device configured to provide visual information. The visual information may include textual information, non-textual information, or a combination of textual information and non-textual information. A display may comprise a screen, an indicator, and/or the like. For example, a screen may be configured to provide textual information and non-textual information, and an indicator may be configured to provide only non-textual information.

A display may comprise a complex display, such as a liquid crystal display (LCD), light emitting diode (LED) display, organic light emitting diode (OLED) display, active-matrix organic light emitting diode (AMOLED) display, micro light emitting diode (microLED) display, electroluminescent display (ELD), plasma display panel (PDP) display), or any other display configured to provide high resolution visual information.

A display may comprise a simple display, such as a light emitting diode (LED), a xenon flash tube, a dot-matrix display, or any other display configured to provide low resolution visual information. The LED may be a direct in-line package (DIP) LED, a surface mounted device (SMD) LED, or a chip on board (COB) LED. The simple display may comprise one or more individual LEDs configured to individually present visual information to a user. Unlike a complex display, a simple display may not be configured to present visual information via a combination of illumination signals emitted by multiple elements of the simple display concurrently. For example, a simple display may not be configured to present an image captured by recording device 110 or another recording device.

In various embodiments, a display may comprise a status display configured to display one or more indications of a status information of recording device 110. For example, the status information may comprise a mode of operation of recording device 110, de-escalation progress, an amount of power remaining in a battery or other power supply of recording device 110, a strength of connection to a wireless network, and/or the like. In various embodiments, a simple display may comprise a status display.

In various embodiments, a display may comprise an ownership display configured to display one or more indications of an ownership information of recording device 110. For example, the ownership information may comprise an incident responder identifier (e.g., name, employee identifier, badge number, etc.), a company identifier (e.g., name, logo, symbol, etc.), an authority identifier, and/or the like. In various embodiments, a simple display may comprise an ownership display.

A simple display may comprise a non-video display. The non-video display may be precluded from displaying video information in accordance with one or more technical properties of the non-video display. For example, the non-video display may lack pixels for displaying image data captured by recording device 110 and/or otherwise lack a minimum resolution necessary for displaying image data captured by the camera.

In various embodiments, a display may be configured to provide a visual output having a color (e.g., a color display). In various embodiments, a display may be configured to provide a visual output in black and white (e.g., a non-color display).

In various embodiments, a display may comprise a user programmable display. In that regard, a memory of a recording device may store user display settings. The user display settings may be updatable (e.g., configurable, programmable, etc.) by a user (e.g., an incident responder, owner of the recording device, etc.). The user display settings may influence a visual output of the display. For example, the user display settings may define ownership information. As a further example, the user display settings may define event-based visual outputs (e.g., visual outputs to display in response to an event). As a further example, the user display settings may define a color, a motion (e.g., animation, movement, etc.), a symbol, and/or the like.

In various embodiments, the user display settings may be associated with a mount. The user display settings may be retrieved by a processor of a recording device based on the mount. The mount may be configured to attach to a mounting surface or mounting interface of a recording device. For example, the mount may comprise indicia indicating the user display settings. For example, the mount may be associated with a mount identifier. The mount identifier may be associated with the user display settings. A recording device may determine (e.g., detect) the mount identifier. The recording device may retrieve the user display settings associated with the mount identifier. As a further example, the mount may comprise memory and/or indicia containing the user display settings. A recording device may retrieve or receive the user display settings from the mount.

In various embodiments, a recording device may comprise a first display and a second display. The first display may be different from the second display. The first display may comprise characteristics different from the second display. The first display may comprise physical characteristics different from the second display. The first display may comprise electrical and/or electronic characteristics different from the second display.

The first display may provide information independent of the second display. The second display may provide information independent of the first display. The first display and the second display may provide different information. The first display and the second display may provide unrelated information. For example, the first display may provide first information, the second display may provide second information, and the first information may be different and/or unrelated from the second information.

The first display and the second display may comprise different types of displays. For example, the first display may comprise a first display type, the second display may comprise a second display type, and the first display type may be different from the second display type. As a further example, the first display may comprise a simple display and the second display may comprise a complex display. As a further example, the first display may comprise an ownership display and the second display may comprise a status display. As a further example, the first display may comprise a user programmable display and the second display may not comprise a user programmable display. As a further example, the first display may comprise a color display and the second display may comprise a black and white (e.g., non-color) display.

The first display and the second display may comprise different resolutions. For example, the first display may comprise a first resolution, the second display may comprise a second resolution, and the first resolution may be different from the second resolution. As a further example, the first display may comprise a first resolution, the second display may comprise a second resolution, and the first resolution may comprise a lower resolution than the second resolution.

The first display and the second display may comprise different densities of light emitting elements (e.g., LEDs). For example, the first display may comprise a first density of light emitting elements, the second display may comprise a second density of light emitting elements, and the first density of light emitting elements may be different from the second density of light emitting elements. As a further example, the first display may comprise a first density of light emitting elements, the second display may comprise a second density of light emitting elements, and the first density of light emitting elements may be less than the second density of light emitting elements.

The first display and the second display may comprise different capabilities. For example, the first display may comprise a first capability, the second display may comprise a second capability, and the first capability may be different from the second capability. As a further example, the first display may comprise a first capability, the second display may comprise a second capability, and the first capability may be less than the second capability.

The first display and the second display may comprise different dimensions. For example, the first display may comprise a first dimension, the second display may comprise a second dimension, and the first dimension may be different from the second dimension.

The first display and the second display may be located on different surfaces of the recording device. For example, the first display may be located on a first surface, the second display may be located on a second surface, and the first surface may be different from the second surface. As a further example, the first display may be located on a front surface and the second display may be located on a top surface of the recording device.

The first display and the second display may be oriented in different directions (e.g., aimed at a different point, etc.). For example, the first display may be oriented in a first direction, the second display may be oriented in a second direction, and the first direction may be different than the second direction. As a further example, the first display may be oriented in a forward direction and the second display may be oriented in an upward direction. As a further example, the first display may be oriented towards a suspect in an incident and the second display may be oriented towards an incident responder in the incident. As a further example, the first display may be oriented away from a user of a recording device and the second display may be oriented towards the user of the recording device.

The first display and the second display may consume different amounts of power (e.g., energy) during operation. For example, the first display may be configured to consume a first amount of power during an operating time period, the second display may be configured to consume a second amount of power during the operating time period, and the first amount of power may be different from the second amount of power. As a further example, the first display may be configured to consume a first amount of power during an operating time period, the second display may be configured to consume a second amount of power during the operating time period, and the first amount of power may be less than the second amount of power.

In various embodiments, recording device 110 may comprise a first display, such as first display 118-1 and a second display, such as second display 118-2. First display 118-1 may be oriented in a same direction as lens 115 and field of view 116. First display 118-1 may be viewable by other persons near recording device 110, such as suspect 140. In accordance with recording device 110 being worn by an incident responder, a housing of recording device 110 may obstruct first display 118-1 from view by incident responder 120. First display 118-1 may comprise an indicator. First display 118-1 may provide information, such as a recording status or ownership information of recording device 110, to a person other than the incident responder, such as suspect 140. For example, first display 118-1 may comprise a simple display.

In various embodiments, second display 118-2 may be oriented in a different direction as lens 115. For example, second display 118-2 may be oriented such that a housing of recording device 110 does not obstruct second display 118-2 from incident responder 120. A housing of recording device 110 may obstruct second display 118-2 from suspect 140. Second display 118-2 may be oriented perpendicular to first display 118-1. Second display 118-2 may comprise a screen. Second display 118-2 may be configured to provide information, such as status information or a remaining battery capacity of recording device 110. For example, second display 118-2 may comprise a complex screen.

In various embodiments, the first display may provide information at least partially the same as information provided by the second display. For example, each of the first display and the second display may provide the same information in different directions. As a further example, each of the first display and the second display may provide the same information in different visual formats. For example, the first display may provide a recording status in a first visual format, the second display may provide the recording status in a second visual format, and the first visual format may be different from the second visual format.

In various embodiments, the first display may provide information partially different than information provided by the second display. For example, the first display may provide information not provided by the second display.

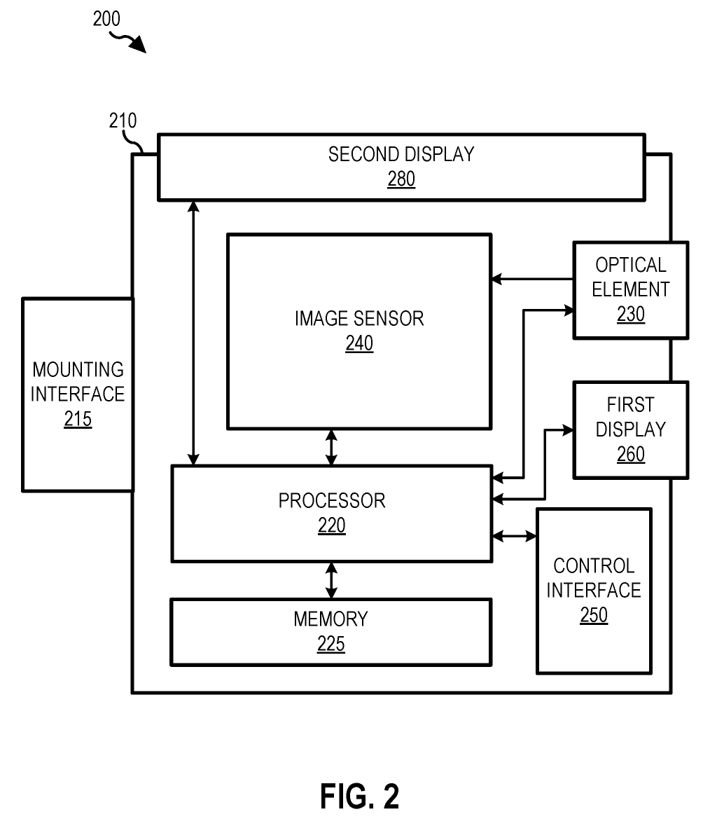

In various embodiments, and with reference to FIG. 2, a recording device 200 is disclosed. Recording device 200 may be similar to, or share similar aspects or components with, any recording device previously disclosed herein (e.g., recording device 110, etc.). Recording device 200 may comprise any suitable device configured to capture incident information. For example, recording device 200 may comprise a body-worn camera, a smart phone, an in-car camera, or the like. It should be understood by one skilled in the art that FIG. 2 is a schematic representation of recording device 200, and one or more of the components of recording device 200 may be located in any suitable position within, or external to, a body of recording device 200. Further, while exemplary couplings may be depicted in FIG. 2, and discussed with particular reference to FIG. 2, it should be understood that other couplings between components of recording device 200 may exist, including electrical, electronic, and/or mechanical couplings. In various embodiments, recording device 200 may comprise a computer-based system.

In various embodiments, recording device 200 may comprise a body 210 (e.g., housing) defining an outer surface of recording device 200. Body 210 may comprise mechanical features configured to couple recording device 200 to a surface. Body 210 may be configured to couple (e.g., mount) to a user. For example, the mechanical features may be configured to interface with an article of clothing or a mount assembly on a user. Body 210 may mount to a location on the user (e.g., a mount location, a second location, etc.). For example, body 210 may mount to a belt mount, a chest mount, or a shoulder mount on the user. In response to being mounted to the location on the user, recording device 200 may be positioned to capture incident information at a fixed position relative to the user. In other embodiments, body 210 may also be configured to mount on or in a vehicle or similar platform. For example, body 210 may comprise a mount interface, such as mount interface 215. Mount interface 215 may extend from body 210 and be configured to couple with a mount. Mount interface 215 may comprise any suitable mount interface.

In various embodiments, body 210 may be configured to house (fully and/or at least partially) various mechanical, electrical, and/or electronic components configured to aid in performing the functions of recording device 200. For example, and in accordance with various embodiments, body 210 may be configured to house (fully and/or at least partially) an optical element 230, an image sensor 240, a processor 220, a memory 225, a first display 260, a second display 280, a control interface 250, and/or the like. As a further example, and in accordance with various embodiments, the body may be configured to house various internal electronic components such as a processor, a memory, a network interface, a power supply, an image sensor, and/or the like.

In various embodiments, processor 220 may comprise any circuitry, electrical components, electronic components, software, and/or the like configured to perform various operations and functions discussed herein. For example, processor 220 may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, processor 220 may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, processor 220 may include data buses, output ports, input ports, timers, memory, arithmetic units, and/or the like.

In various embodiments, processor 220 may be configured to provide and/or receive electrical signals whether digital and/or analog in form. Processor 220 may provide and/or receive digital information via a data bus using any protocol. Processor 220 may receive information, manipulate the received information, and provide the manipulated information. Processor 220 may store information and retrieve stored information. Information received, stored, and/or manipulated by processor 220 may be used to perform a function, control a function, and/or to perform an operation or execute a stored program. Processor 220 may control the operation and/or function of other circuits and/or components of recording device 200. Processor 220 may receive status information regarding the operation of other components, perform calculations with respect to the status information, and provide commands (e.g., instructions) to one or more other components. Processor 220 may command another component to start operation, continue operation, alter operation, suspend operation, cease operation, or the like. Commands and/or status may be communicated between processor 220 and other circuits and/or components via any type of bus (e.g., SPI bus) including any type of data/address bus. In various embodiments, processor 220 may be in electrical, electronic, and/or mechanical communication with one or more components of recording device 200. For example, processor 220 may be in communication with memory 225, optical element 230, image sensor 240, first display 260, second display 280, control interface 250, and/or the like.

In various embodiments, memory 225 may comprise one or more memory, data structures, or the like configured to store data, programs, and/or instructions. Memory 225 may be in electrical and/or electronic communication with processor 220. In some embodiments, memory 225 may also be in electrical and/or electronic communication with image sensor 240, first display 260, second display 280, and/or any other suitable component of recording device 200.

In various embodiments, memory 225 may comprise a tangible, non-transitory computer-readable memory. Instructions stored on the tangible non-transitory memory may allow the processor to perform various operations, functions, and/or steps, as described herein. For example, in response to processor 220 executing the instructions on the memory 225, processor 220 may communicate with image sensor 240 to capture image data, end capturing of the image data, and/or the like, as discussed further herein. As a further example, in response to processor 220 executing instructions on memory 225, processor 220 may communicate with first display 260 and/or second display 280 to provide visual information as discussed herein. As another example, processor 220 may execute instructions in response to operation of control interface 250, as discussed further herein. In embodiments, memory 225 may also be configured to receive, store, and maintain incident recordings, including captured image data. In that regard, memory 225 may include a storage medium, data structure, database, memory unit, hard-disk drive (HDD), solid state drive (SSD), removable memory, and/or the like.

In various embodiments, processor 220 may comprise or be in electronic communication with a communications unit (e.g., a network interface, a communications module, etc.). The communications unit may be similar to, or comprise similar components with, any other communications unit, short-range communications unit, long-range communications unit, or the like disclosed here. The communications unit may enable electronic communications between devices and systems. The communications unit may enable communications over a network. For example, the communications unit may include a modem, a network interface (such as an Ethernet card), a communications port, or the like. Data may be transferred via the communications unit in the form of signals which may be electronic, electromagnetic, optical, or other signals capable of being transmitted or received by a communications unit. The communications unit may be configured to communicate via any wired protocol, wireless protocol, or other protocol capable of transmitting information via a wired or wireless connection. In various embodiments, the communications unit may be configured to enable short-range communications between devices. In various embodiments, the communications unit may be configured to enable long-range communications between devices or systems. In various embodiments, the communications unit may be configured to enable both short-range communications and long-range communications.

In various embodiments, optical element 230 may be similar to any other lens, optical element, or the like disclosed herein. Optical element 230 may comprise a lens and/or lens assembly configured to focus light onto image sensor 240 for detection. A portion of optical element 230 (e.g., a lens, a bezel, a lens barrel, etc.) may extend through body 210. Body 210 may house a portion of optical element 230. Optical element 230 may be disposed adjacent image sensor 240. Optical element 230 may comprise optical materials, such as low dispersion materials, glass materials, plastic materials, etc.

In various embodiments, image sensor 240 may be configured to detect (e.g., generate, capture, etc.) raw (e.g., sensor) image data from light. Image sensor 240 may capture image data continuously as sequential frames. The sequential frames may be presented serially to provide video data. Image sensor 240 may comprise a charge-coupled device (CCD), a complementary metal-oxide sensor (CMOS), or any other sensor suitable of detecting raw image data from light. Image sensor 240 may be configured to detect visible light and/or near-infrared light. Image sensor 240 may comprise a color filter array (e.g., color filter stack) configured to filter particular wavelengths of light to corresponding sites of a pixel array of image sensor 240. For example, image sensor 240 may comprise a Bayer-filter comprising red, green, and blue (RGB) color filters that filter visible wavelengths of light to specific pixels of the pixel array for image detection. As a further example, image sensor 240 may comprise a sensor sensitive to red, green, blue, and infrared light, such as an RGB-IR sensor. An RGB-IR sensor may comprise red, green, blue, and infrared color filters configured to filter visible and infrared light to specific pixels of a pixel array for image detection.

In various embodiments, image sensor 240 may be configured to capture an image or series of images (e.g., video). For example, during an incident recording image sensor 240 may be configured to capture an image or series of images of the incident recording. Image sensor 240 may be in electric and/or electronic communication with processor 220, memory 225, and/or ambient light detector 290. Image sensor 240 may receive instructions from processor 220, and/or provide signals corresponding with data detected by image sensor 240 to processor 220. As another example, image sensor 240 may provide analog data or digital data corresponding with light detected by image sensor 240 to memory 225. Processor 220 may control (e.g., instruct) image sensor 240 (and/or optical element 230) to begin capturing images and to end capturing of the images. Processor 220 may also control (e.g., instruct) image sensor 240 to transmit the captured images to memory 225 for storage. Image sensor 240 may transmit (e.g., stream) the captured images to memory 225 (directly or via processor 220) as the images are captured or in response to image sensor 240 ending capturing of the images.

In various embodiments, recording device 200 may comprise a power supply (e.g., power source, battery, etc.). The power supply may be configured to provide power to one or more electric and/or electronic components of the recording device. The power supply may provide energy for operating electronic and/or electrical components (e.g., parts, subsystems, circuits, etc.). The power supply may provide electrical power. The power supply may include a battery, or a plurality of batteries. The energy of the power supply may be renewable or exhaustible, and/or replaceable. For example, the power supply may comprise one or more rechargeable or disposable batteries. Provision of power from the power supply may be controlled by processor 220. Processor 220 may monitor and/or record a power level or remaining power of the power supply.

In various embodiments, recording device 200 may comprise one or more components configured to receive an input from a user. For example, recording device 200 may comprise one or more of an audio capturing module (e.g., microphone) configured to receive an audio input, a visual display (e.g., touchscreen, LCD, LED, etc.) configured to receive a manual input, a mechanical interface (e.g., button, switch, etc.) configured to receive a manual input, and/or the like.

In various embodiments, recording device 200 may comprise one or more components configured to transmit or produce an output. For example, recording device 200 may comprise one or more of an audio output module (e.g., audio speaker) configured to output audio, a visual display (e.g., touchscreen, LCD, LED, etc.) configured to output a visual, and/or the like.

In various embodiments, control interface 250 may be configured to enable a user to interact with recording device 200. For example, control interface 250 may be configured to enable the user to control operation of recording device 200, including enabling and disabling power of recording device 200, starting and stopping recording of image data, increasing or decreasing a volume of audio output, selecting an operating mode, programming an operating mode, initiating communications with an external device (e.g., two-way communication), and/or the like. Control interface 250 may be in electrical, electronic, and/or mechanical communication with processor 220.

Control interface 250 may comprise any suitable hardware, software, mechanical, and/or electronic components configured to enable the user interaction. For example, and in accordance with various embodiments, control interface 250 may comprise a button, switch, or the like. In that regard, control interface 250 may be configured to move, slide, rotate, or otherwise become physically depressed or translated upon application of physical contact. As a further example, and in accordance with various embodiments, control interface 250 may comprise a touchscreen or similar interface enabling user input. As a further example, and in accordance with various embodiments, control interface 250 may include voice control technology. In that regard, control interface 250 may at least partially integrate with an audio capturing module to receive voice commands (e.g., “Record”, “Stop Record”, “Capture Image”, “Record Audio”, etc.). Voice command technology is well known in the art, and control interface 250 may implement any suitable voice command technology.

In various embodiments, control interface 250 may include an authorization control configured to control access and operation of recording device 200. For example, control interface 250 may comprise a biometric authorization control, such as a fingerprint reader, configured to control access and operation of recording device 200. Authorization controls and biometric authorization controls are well known in the art, and control interface 250 may implement any suitable authorization control technology and/or biometric authorization technology.

In various embodiments, in response to control interface 250 receiving an activation event (e.g., physical activation, voice activation, touch-screen selection or activation, etc.), processor 220 may be configured to perform various operations. For example, in response to control interface 250 of recording device 200 receiving the activation event, processor 220 may determine or detect the activation event and instruct image sensor 240 to capture an image or series of images.

In various embodiments, first display 260 may be similar to any other first display, display, or the like disclosed herein. First display 260 may be configured to visually display data (e.g., information). First display 260 may be configured to visually display data (e.g., information) regarding recording device 200 and/or an incident recording. Operation of first display 260 may be at least partially controlled by processor 220.

In various embodiments, first display 260 may comprise a simple display. First display 260 may comprise a non-video display. First display 260 may comprise a color display. First display 260 may comprise a user programmable display. First display 260 may be configured to visually display information. First display 260 may be configured to visually display ownership information. First display 260 may be configured to display a recording status.

In various embodiments, first display 260 may comprise a dot-matrix display.

In various embodiments, second display 280 may be similar to any other second display, display, or the like disclosed herein. Second display 280 may be configured to visually display data (e.g., information). Second display 280 may be configured to visually display data (e.g., information) regarding recording device 200 and/or an incident recording. Operation of second display 280 may be at least partially controlled by processor 220.

In various embodiments, second display 280 may comprise a complex display. Second display 280 may comprise a non-video display. Second display 280 may comprise a non-color display. Second display 280 may comprise a non-user programmable display. Second display 280 may be configured to visually display information. Second display 280 may be configured to display status information. Second display 280 may be configured to display configuration information. For example, second display 280 may be configured to display data such as a recording device battery level, a date, a time, an incident recording status (e.g., recording, paused, etc.), an incident recording length (e.g., an elapsed time of the incident recording), an incident recording start time, or the like.

In various embodiments, second display 280 may comprise an LED display.

In embodiments, recording device 200 may operate in different modes or operating states (e.g., operating modes). Processor 220 may be communicatively coupled to one or more other components to control the components to perform one or more operations associated with the different modes. For example, the different modes may comprise a pre-event mode, an event mode, a stealth mode, a display status mode, a normal mode, and/or any other suitable operating mode. Selection of different modes may be enabled by processor 220. Selection of different modes may be received from a user via control interface 250.

In various embodiments, a pre-event mode may enable information to be captured before indication of an incident is provided to recording device 200. In the pre-event mode, processor 220 may control image sensor 240 to capture video information. The video information may be buffered as video data in memory 225. In accordance with pre-event mode, the video information may be temporarily stored in memory 225. The video information may be buffered in a circular buffer. The video information may be buffered in a first-in-first-out basis. An amount of the video information buffered may be limited in accordance with a maximum buffer size and/or time. When the maximum buffer size has been buffered or the maximum buffer time has been exceeded, oldest stored video information may be deleted, overwritten, or otherwise rendered inaccessible in memory 225. For example, oldest buffered video data may be overwritten with newer video data corresponding to most recently captured video information. New video data may be continuously buffered in accordance with the pre-event mode. Oldest video data may be continuously rendered inaccessible in accordance with the pre-event mode. In accordance with the pre-event mode, information indicating the pre-event mode may be provided via one or more of first display 260 or second display 280. For example, second display 280 may display a graphical icon indicative of the pre-event mode. First display 260 may provide an illumination signal indicative of the pre-event mode. For example, the illumination signal may comprise a first color being displayed via an LED of first display 260. Alternately or additionally, the illumination signal may comprise a first pattern associated with the pre-event mode. For example, an LED of first display may display a steady or continuous illumination signal in accordance with the pre-event mode. In embodiments, recording device 200 may enter pre-event mode in accordance with an input received via control interface 250.

In embodiments, an event mode may enable information to be captured after indication of an incident is provided to recording device 200. Recording device 200 may receive the indication of the event and enter the event mode responsive to the indication. Recording device 200 may enter (e.g., change from another mode, begin operating in, etc.) the event mode from the pre-event mode. Recording device may operate in the event mode prior to operating in the pre-event mode and/or after operating in the pre-event mode. In the event mode, processor 220 may control image sensor 240 to capture video information. The video information may be further stored as video data in memory 225. In accordance with the event mode, the video information may be stored in non-volatile memory of memory 225. The video information may be non-temporarily stored. The video information may preserve video information associated with the incident until another indication is received that indicates that video information should no longer be captured for the incident. The video information stored in accordance with an event mode may be prevented from being automatically overwritten, including after a period of time. The duration of the video information may be limited by a size of memory 225 or an amount of power in power supply of recording device 200, rather than a pre-determined limit as provided for a pre-event mode. In accordance with the event mode, information indicating the event mode may be provided via one or more of first display 260 or second display 280. For example, second display 280 may display a graphical icon indicative of the event mode. The icon may be different from a first icon provided for a pre-event mode. First display 260 may provide another illumination signal indicative of the event mode. For example, the illumination signal may comprise a second color being displayed via an LED of first display 260. The second color (e.g., red) may be different from a first color (e.g., green) associated with a pre-event mode of the recording device 200. Alternately or additionally, the illumination signal may comprise a second pattern associated with the event mode. For example, an LED of first display 260 may display an intermittent illumination signal in accordance with the event mode. The second pattern (e.g., blinking) may be different from a first pattern (e.g., steady) associated with a pre-event mode of the recording device 200. In embodiments, recording device 200 may enter event mode in accordance with an indication of an incident being received via control interface 250.

In a stealth mode, displays of recording device 200 may be disabled. The stealth mode may disable the displays to prevent distraction or decrease visibility of recording device 200 in an environment. In accordance with a stealth mode, processor 220 may disable first display 260 and second display 280. Disabling first display 260 and second display 280 may comprise one or more of removing power from the displays and/or preventing information from being provided from first display 260 and second display 280. In embodiments, stealth mode may be applied or entered by recording device 200 concurrently with a pre-event mode and event mode of recording device 200. Rather than providing information associated with one or more of these modes, first display 260 and/or second display 280 may be disabled. Accordingly, the stealth mode may supersede the event mode or pre-event mode with regarding to an operation performed otherwise performed via one or more displays of the recording device.

In a discrete mode, first display 260 (e.g., a front display) of recording device 200 may be disabled. The discrete mode may disable first display 260 to decrease visibility of recording device 200 or prevent distraction otherwise caused by the display in an environment near recording device 200. In the discrete mode, second display 280 (e.g., a top display) may remain operational. Accordingly, a wearer of recording device 200 may still be able to receive information from the recording device 200 via second display 280. In accordance with discrete mode, processor 220 may disable first display 260. In accordance with discrete mode, processor 220 may provide information via second display 280. In accordance with discrete mode, processor 220 may continuously provide information via second display 280, independent of first display 260 being disabled. Disabling the display 260 may comprise one or more of removing power from the display 260 and/or preventing information from being provided from display 260. In embodiments, discrete mode may be applied or entered by recording device 200 concurrently with a pre-event mode and event mode of recording device 200. Rather than providing information associated with one or more of these modes, first display 260 may be disabled. Accordingly, the discrete mode may supersede the event mode or pre-event mode with regarding to an operation performed otherwise performed via one or more displays of the recording device. The discrete mode may be entered or applied via recording device 200 separately from the stealth mode.

In embodiments, recording device 200 may further comprise a normal mode. In a normal mode, each of first display 260 and second display 280 of recording device 200 may be activated. For example, each of first display 260 and second display 280 may provide information in accordance with a normal mode of recording device 200 as controlled by processor 220. Normal mode may be entered when neither stealth mode nor discrete mode are applied. Accordingly, recording device 200 may be operated in one of a normal mode, a stealth mode, or a discrete mode according to various aspects of the present disclosure. Information provided, if any, in accordance with such modes may be further provided in accordance with a pre-event mode or recording mode concurrently performed by (e.g., applied to, implemented by, etc.) recording device 200.

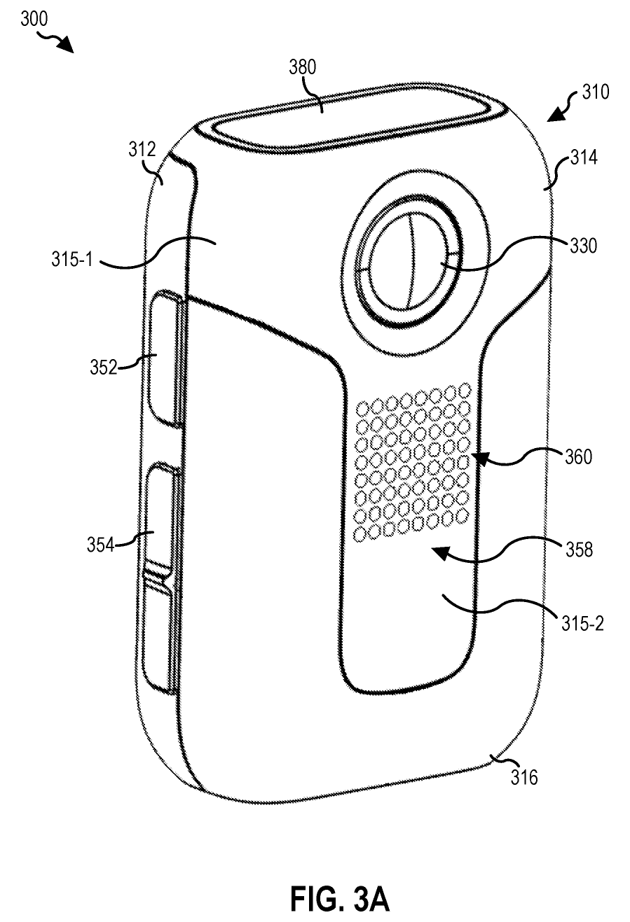

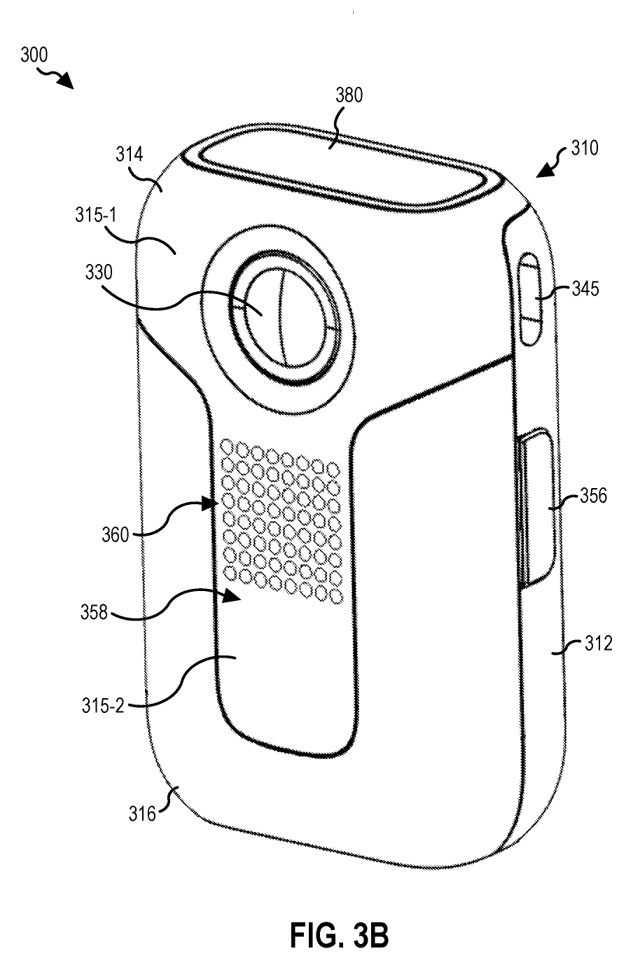

In various embodiments, and with reference to FIGS. 3A and 3B, a recording device 300 is disclosed. Recording device 300 may be similar to, or share similar aspects or components with, any recording device discussed previously herein (e.g., recording device 110, with brief reference to FIG. 1, recording device 200, with brief reference to FIG. 2, etc.). One or more elements or features of recording device 300 may correspond with one or more elements or features of any recording device discussed previously herein. In various embodiments, recording device 300 may comprise a computer-based system.

In various embodiments, recording device 300 may comprise a body 310. Body 310 may be similar to, or share similar aspects or components with, any body of a recording device discussed previously herein. Body 310 may comprise a plurality of ends (e.g., surfaces) including a front end (e.g., first end, front, front surface, etc.), a rear end (e.g., second end, rear, back, rear surface, etc.), a top end (e.g., third end, top, top surface, etc.), a bottom end (e.g., fourth end, bottom, bottom surface, etc.), a first side end (e.g., fifth end, left side end, left side, first side surface, etc.), and/or a second side end (e.g., sixth end, right side end, right side, second side surface, etc.).

The front end may be opposite the rear end. The top end may be opposite the bottom end. The first side end may be opposite the second side end. The front end may connect the top end and the bottom end and the first side end and the second side end. The rear end may connect the top end and bottom end and the second side end and the first side end. The top end may connect the front end and the rear end and the first side end and the second side end. The bottom end may connect the front end and the rear end and the first side end and the second side end. The first side end may connect the front end and the rear end and the top end and the bottom end. The second side end may connect the front end and the rear end and the top end and the bottom end.

In various embodiments, body 310 may comprise a rearward surface 312 opposite a forward surface. Rearward surface 312 may be opposite the forward surface. Rearward surface 312 and the forward surface may define outer surfaces of body 310.

In various embodiments, rearward surface 312 may define the rear end of body 310. Rearward surface 312 may define a portion of the bottom end of body 310. Rearward surface 312 may define a portion of the first side end and/or the second side end of body 310. In some embodiments, rearward surface 315 may comprise a single (e.g., monolithic, unitary, etc.) body defining the surface).

In various embodiments, the forward surface may define the front end of body 310. The forward surface may define the top end of body 310. The forward surface may define a portion of the bottom end of body 310. The forward surface may define a portion of the first side end and/or the second side end of body 310.

In various embodiments, the forward surface may comprise a plurality of bodies defining the surface. For example, the forward surface may comprise or be defined by a first forward surface 314 and a second forward surface 316. First forward surface 314 may define a portion of the front end of body 310. First forward surface 314 may define the top end of body 310. First forward surface 314 may define a portion of the first side end and/or the second side end of body 310. Second forward surface 316 may define a portion of the front end of body 310. Second forward surface 316 may define a portion of the body end of body 310. Second forward surface 316 may define a portion of the first side end and/or the second side end of body 310. Second forward surface 316 may comprise a static (e.g., non-translatable) surface.

First forward surface 314 may define an upper portion of the forward surface. Second forward surface 316 may define a lower portion of the forward surface. First forward surface 314 may comprise a wide region and an extended region (e.g., a tongue). The wide region may define an upper portion of first forward surface 314. The extended region may define a lower portion of first forward surface 314. The extended region may extend downward from the wide region. The extended region may extend downward towards second forward surface 316. Second forward surface 316 may comprise a recess (e.g., a groove) extending downward towards the bottom end of body 310. The extended region of first forward surface 314 may be surrounded by the recess of second forward surface 316. The extended region of first forward surface 314 may be sized and shaped to be received into the recess of second forward surface 316. The recess of second forward surface 316 may be sized and shaped to receive the extended region of first forward surface 314. The recess may comprise a U shape, a V shape, and/or any other suitable shape. The extended region may comprise a shape complimentary with the recess.

In various embodiments, first forward surface 314 may comprise or be defined by a first forward surface static portion 315-1 and a first forward surface translatable portion 315-2. First forward surface static portion 315-1 may comprise or define a wide region of first forward surface 314. First forward surface static portion 315-1 may comprise a static surface (e.g., non-translatable surface). First forward surface translatable portion 315-2 may comprise or define an extended region of first forward surface 314. First forward surface translatable portion 315-2 may comprise a translatable surface (e.g., non-static surface, tactile surface, pressable surface, etc.). For example, a user may push (e.g., press) on first forward surface translatable portion 315-2 and in response, first forward surface translatable portion 315-2 may be configured to depress inward. As discussed further herein, and in accordance with various embodiments, depression of first forward surface translatable portion 315-2 may operate a control interface.

In various embodiments, recording device 300 may comprise a mount interface. The mount interface may extend from, or be defined on, the rear end of body 310. The mount interface may extend from, or be defined on, rearward surface 312. The mount interface may be similar to any other mounting interface or the like disclosed herein. The mount interface may be configured to couple to a provided mount. Recording device 300 may be configured to releasably couple to a provided mount via the mount interface. The mount interface may include a connector, such as a bayonet style connector. The mount interface may include a receiver, such as a female receiver. The mount interface may oppose optical element 330 and/or first display 370, as discussed further herein.

In various embodiments, body 310 may be configured to house (fully and/or at least partially) various mechanical, electrical, and/or electronic components configured to aid in performing the functions of recording device 300. For example, and in accordance with various embodiments, body 310 may be configured to house (fully and/or at least partially) an optical element 330, one or more control interfaces, a first display 360, a second display 380, and/or the like. Optical element 330 may be similar to any other optical element disclosed herein. The one or more control interfaces may be similar to any other control interface disclosed herein. First display 360 may be similar to any other display, first display, or the like disclosed herein. Second display 380 may be similar to any other display, second display, or the like disclosed herein.

As a further example, body 310 may be configured to house (fully and/or at least partially) one or more of a processor, a memory, an image sensor, a communications unit, a power supply, an audio capturing module, an audio output module, and/or the like. The processor may be similar to any other processor disclosed herein. The memory may be similar to any other memory disclosed herein. The image sensor may be similar to any other image sensor disclosed herein. The communications unit may be similar to any other communications unit disclosed herein. The power supply may be similar to any other power supply disclosed herein. The audio capturing module may be similar to any other audio capturing module disclosed herein. The audio output module may be similar to any other audio output module disclosed herein.

In various embodiments, optical element 330 may be disposed on a front surface of body 310. Optical element 330 may be disposed on first forward surface 314. Optical element 330 may be disposed on first forward surface static portion 315-1. Optical element 330 may extend through an aperture (e.g., opening, etc.) on body 310. Optical element 330 may oppose the mount interface. Optical element 330 may comprise an optical axis. Optical element 330 may be symmetric about the optical axis. Optical element 330 may be oriented along the optical axis.

In various embodiments, the one or more control interfaces of recording device 300 may comprise a first control interface 352, a second control interface 354, a third control interface 356, an event interface 358, and/or any other suitable or desired other control interfaces. First control interface 352, second control interface 354, third control interface 356, and event interface 358 may be similar to any other control interface disclosed herein. First control interface 352, second control interface 354, third control interface 356, and event interface 358 may comprise any suitable type of interface. For example, first control interface 352, second control interface 354, third control interface 356, and event interface 358 may each comprise a switch, a push button switch, an electromechanical switch, a toggle switch, a button, a trigger, and/or the like.

In various embodiments, first control interface 352 may be disposed on a first side end of body 310. First control interface 352 may be disposed on rearward surface 312. First control interface 352 may be configured to enable a user of recording device 300 to control operation of recording device 300. For example, first control interface 352 may be configured to enable or disable power, increase or decrease a volume of audio output, select an operating mode, program an operating mode, initiate communications with an external device (e.g., two-way communication with a next recording device), and/or the like. First control interface 352 may enable and/or control different operations than second control interface 354, third control interface 356, and event interface 358.

In various embodiments, second control interface 354 may be disposed on a first side end of body 310. Second control interface 354 may be disposed on rearward surface 312. Second control interface 354 may be configured to enable a user of recording device 300 to control operation of recording device 300. For example, second control interface 354 may be configured to enable or disable power, increase or decrease a volume of audio output, select an operating mode, program an operating mode, initiate communications with an external device (e.g., two-way communication with a next recording device), and/or the like. Second control interface 354 may enable and/or control different operations than first control interface 352, third control interface 356, and event interface 358.

In various embodiments, third control interface 356 may be disposed on a second side end of body 310. Third control interface 356 may be disposed on rearward surface 312. Third control interface 356 may be positioned opposite first control interface 352 and/or second control interface 354. Third control interface 356 may be configured to enable a user of recording device 300 to control operation of recording device 300. For example, third control interface 356 may be configured to enable or disable power, increase or decrease a volume of audio output, select an operating mode, program an operating mode, initiate communications with an external device (e.g., two-way communication with a next recording device), and/or the like. Third control interface 356 may enable and/or control different operations than first control interface 352, second control interface 354, and event interface 358.

In various embodiments, event interface 358 may be disposed on a front surface of body 310. Event interface 358 may be disposed on a forward surface of body 310. Event interface 358 may be disposed on first forward surface 314. Event interface 358 may be disposed below optical element 330 on first forward surface 314. Event interface 358 may be disposed on first forward surface translatable portion 315-2. Event interface 358 may be disposed on first forward surface translatable portion 315-2 and surrounded by first forward surface static portion 315-1 and second forward surface 316. Event interface 358 may be disposed on first forward surface translatable portion 315-2 and surrounded by first forward surface static portion 315-1 at an upper end and second forward surface 316 at a lower end and each side end.

In various embodiments, event interface 358 may be disposed beneath first forward surface translatable portion 315-2. For example, event interface 358 may comprise a push button switch. In that regard, a user force (e.g., pressure) on first forward surface translatable portion 315-2 may operate (e.g., activate) event interface 358. In various embodiments, first forward surface translatable portion 315-2 may comprise event interface 358.

In various embodiments, event interface 358 may be disposed proximate first display 360. Event interface 358 may be disposed below first display 360. Event interface 358 may be disposed beneath first display 360. Event interface 358 may be disposed beneath first forward surface translatable portion 315-2 and first display 360. For example, event interface 358 may comprise a push button switch. In that regard, a user force (e.g., pressure) on first forward surface translatable portion 315-2 and/or first display 360 may operate (e.g., activate) event interface 358. In various embodiments, first display 360 may comprise event interface 358.

In various embodiments, event interface 358 may be configured to enable a user of recording device 300 to control operation of recording device 300. For example, event interface 358 may be configured to control recording of image data and/or the like. Event interface 358 may be configured to start or stop recording of image data and/or the like. As a further example, event interface 358 may be configured to select an operating mode, program an operating mode, initiate communications with an external device (e.g., two-way communication with a next recording device), and/or the like.

In various embodiments, recording device 300 may comprise an auxiliary connection port 345. Auxiliary connection port 345 may be disposed on a second side end of body 310. Auxiliary connection port 345 may be disposed on rearward surface 312. Auxiliary connection port 345 may be positioned proximate third control interface 356. Auxiliary connection port 345 may be positioned above third control interface 356. Auxiliary connection port 345 may be positioned opposite first control interface 352 and/or second control interface 354.

In various embodiments, auxiliary connection port 345 may comprise a power charging port. The power charging port may be configured to allow recording device 300 to receive electrical power from an external source to charge a power supply of recording device 300. The power charging port may comprise an industry-standard connector for providing electrical power to devices, such as, for example, a USB Type-C connection port.

In various embodiments, auxiliary connection port 345 may comprise a data transmission port. The power data transmission may be configured to allow recording device 300 to transmit data to and/or receive data from an external device. The data transmission port may comprise an industry-standard connector for providing data transmission capabilities between devices, such as, for example, a USB Type-C connection port.

In various embodiments, auxiliary connection port 345 may be configured to provide a wired electronic communication between recording device 300 and an external device, such as, for example, an auxiliary recording device. The wired electronic communication may include the transmission of data to and from the devices. The wired electronic communication may include the transmission of power from recording device 300 to the external device. The wired electronic communication may include the transmission of power from the external device to recording device 300. In various embodiments, auxiliary connection port 345 may comprise an industry-standard connector for transmitting both data and power on a single cable, such as, for example, a USB Type-C connection port. In various embodiments, auxiliary connection port 345 may comprise a proprietary connector for transmitting data and power to an auxiliary recording device. The proprietary connector may transmit both data and power on a single cable. The proprietary connector may have a separate power cable and a separate data cable configured to provide the transmissions. In various embodiments, auxiliary connection port 345 may also provide or receive electrical power and/or data transmission via a wireless transmission, such as, for example, through inductive coupling.

In various embodiments, first display 360 may be disposed on a front surface of body 310. First display 360 may be disposed on a forward surface of body 310. First display 360 may be disposed on first forward surface 314. First display 360 may be disposed below optical element 330 on first forward surface 314. First display 360 may be disposed on first forward surface translatable portion 315-2. First display 360 may be disposed on first forward surface translatable portion 315-2 and surrounded by first forward surface static portion 315-1 and second forward surface 316. First display 360 may be disposed on first forward surface translatable portion 315-2 and surrounded by first forward surface static portion 315-1 at an upper end and second forward surface 316 at a lower end and each side end.

In various embodiments, first display 360 may be disposed beneath first forward surface translatable portion 315-2. In various embodiments, first forward surface translatable portion 315-2 may comprise first display 360.

In various embodiments, first display 360 may be disposed proximate event interface 358. First display 360 may be disposed upward (e.g., towards a top end of body 310) from event interface 358. First display 360 may be disposed above event interface 358. First display 360 may be disposed between first forward surface translatable portion 315-2 and event interface 358. In various embodiments, first display 360 may comprise event interface 358.

In various embodiments, first display 360 may be similar to any other first display, display, or the like disclosed herein (e.g., first display 260, with brief reference to FIG. 2). First display 360 may be configured to visually display data (e.g., information). First display 360 may be configured to visually display data (e.g., information) regarding recording device 300 and/or an incident recording. Operation of first display 360 may be at least partially controlled by a processor of recording device 300.

In various embodiments, first display 360 may comprise a simple display. First display 360 may comprise a non-video display. First display 360 may comprise a color display. First display 360 may comprise a user programmable display. First display 360 may be configured to visually display information. First display 360 may be configured to visually display ownership information. First display 360 may be configured to display a recording status.

In various embodiments, first display 360 may comprise a dot-matrix display. First display 360 may comprise any suitable type of dot-matrix display. First display 360 may comprise an electronic display that arranges individual pixels in a rectangular grid to render characters or graphics. Each individual pixel may be defined by a light-emitting element such as an LED. The electronic display may comprise any suitable configuration, size, and shape of light-emitting elements. For example, first display 360 may comprise an electronic display having 8 rows and 8 columns of light-emitting elements (i.e., 64 light emitting elements), as depicted in FIGS. 3A and 3B. As a further example, first display 360 may comprise an electronic display having any other arrangement of light-emitting elements, such as 5 rows and 7 columns of light-emitting elements i.e., 35 light emitting elements) and/or the like.

First display 360 may provide (e.g., present, display, project, etc.) visual information in a direction along the optical axis which optical element 330 is directed. A processor of recording device 300 may control provision of visual information from first display 360, as discussed herein.

In various embodiments, second display 380 may be disposed on a top surface of body 310. Second display 380 may be disposed on a forward surface of body 310. Second display 380 may be disposed on first forward surface 314. Second display 380 may be disposed above optical element 330 on first forward surface 314. Second display 380 may be disposed on first forward surface static portion 315-1. Second display 380 may be disposed on first forward surface static portion 315-1 between optical element 330 and a top end of rearward surface 312.

In various embodiments, second display 380 may be similar to any other second display, display, or the like disclosed herein (e.g., second display 280, with brief reference to FIG. 2). Second display 380 may be configured to visually display data (e.g., information). Second display 380 may be configured to visually display data (e.g., information) regarding recording device 300 and/or an incident recording. Operation of second display 380 may be at least partially controlled by a processor of recording device 300. Operation of second display 380 may be controlled independently of operation of first display 360 by the processor of recording device 300.

In various embodiments, second display 380 may comprise a complex display. Second display 380 may comprise a non-video display. Second display 380 may comprise a non-color display. Second display 380 may comprise a non-user programmable display. Second display 380 may be configured to visually display information. Second display 380 may be configured to display status information. Second display 380 may be configured to display configuration information. For example, second display 380 may be configured to display data such as a recording device battery level, a date, a time, an incident recording status (e.g., recording, paused, etc.), an incident recording length (e.g., an elapsed time of the incident recording), an incident recording start time, or the like.

In various embodiments, second display 380 may comprise a screen. For example, the screen may comprise an LED display, an LCD display, or the like. The screen may comprise a density of light emitting elements, such as LEDs, capable of providing a visual output on the screen.

Second display 380 may provide (e.g., present, display, project, etc.) visual information in a direction towards a user (e.g., operator, incident responder, etc.) of recording device 300. For example, a screen of second display 380 may be oriented upward, such that a user of recording device 300 may view information pertaining to recording device 300. A processor of recording device 300 may control provision of visual information from second display 380, as discussed herein.

In various embodiments, first display 360 and second display 380 may comprise different types of displays. First display 360 and second display 380 may comprise different resolutions. First display 360 and second display 380 may comprise different densities of light emitting elements. First display 360 and second display 380 may comprise different capabilities. First display 360 and second display 380 may consume different amounts of power.

In various embodiments, first display 360 and second display 380 may comprise different dimensions. First display 360 and second display 380 may be located on different surfaces of recording device 300. First display 360 and second display 380 may be oriented in different directions. In various embodiments, second display 380 may be disposed orthogonal to first display 360.

In various embodiments, first display 360 may define a first surface area of a front surface of body 310. The first surface area may be less than 50% of the total surface area of the front surface of body 310. The first surface area may be less than 40% of the total surface area of the front surface of body 310. The first surface area may be less than 30% of the total surface area of the front surface of body 310. The first surface area may be less than 25% of the total surface area of the front surface of body 310. The first surface area may be less than 15% of the total surface area of the front surface of body 310. The first surface area may be less than 10% of the total surface area of the front surface of body 310.

In various embodiments, second display 380 may define a second surface area of a top surface of body 310. The second surface area may be greater than 50% of the total surface area of the top surface of body 310. The second surface area may be greater than 60% of the total surface area of the top surface of body 310. The second surface area may be greater than 70% of the total surface area of the top surface of body 310. The second surface area may be greater than 80% of the total surface area of the top surface of body 310. The second surface area may be greater than 90% of the total surface area of the top surface of body 310.

In various embodiments, first display 360 may define a first height and a first width. The first height may define a height (e.g., distance) of first display 360 measured on the front surface of body 310 between the top surface and the bottom surface of body 310. The first width may define a width (e.g., distance) of first display 360 measured on the front surface of body 310 between the first side surface and the second side surface of body 310.

Second display 380 may define a second height and a second width. The second height may define a height (e.g., distance) of second display 380 measured on the top surface of body 310 between the front surface and the rear surface of body 310. The second width may define a width (e.g., distance) of second display 380 measured on the top surface of body 310 between the first side surface and the second side surface of body 310.

The first height may be different from the second height. The first height may be greater than the second height. The first width may be different from the second width. The first width may be less than the second width.

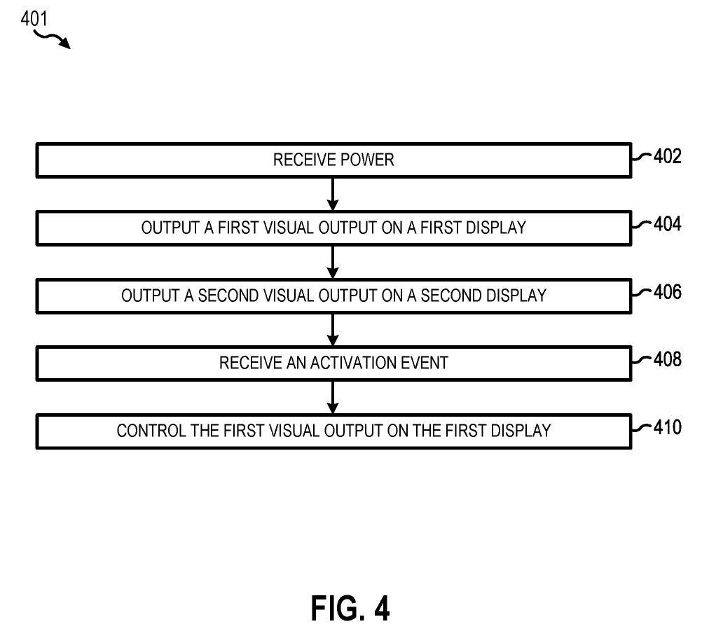

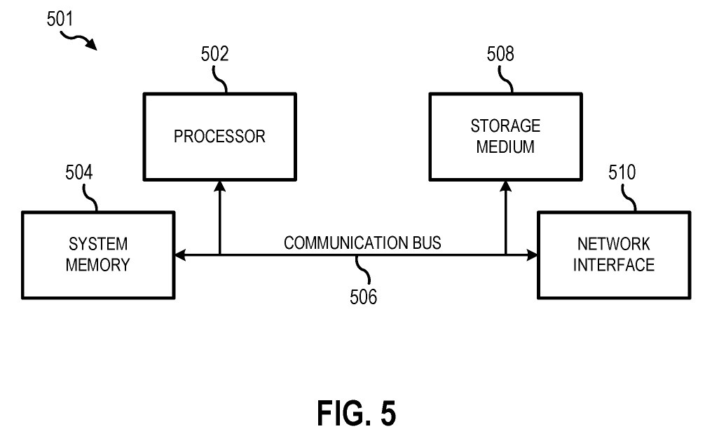

Referring now to FIG. 4, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps depicted in FIG. 4, but also to the various device and system components as described above with reference to FIGS. 1-3 (or below, with reference to FIG. 5).

In various embodiments, and with specific reference to FIG. 4, a method 401 for providing visual outputs on a first display and a second display of a recording device is disclosed. In some embodiments, method 401 may be performed by a device, such as a recording device, a computer-based system, or the like (collectively referred to below as a “device”).

In various embodiments, the device may receive power (step 402). The power (e.g., electrical energy) may be provided to electrical and/or electronic components of the device. For example, the device may receive power from a power supply. The device may receive power in response to the device being operated into a “power on” mode. The device may receive power in response to operation of a control interface of the device. The device may detect and/or enter an operating mode in response to receiving the power.

In various embodiments, the device may output a first visual output on a first display (step 404). The first display may be similar to any other first display disclosed herein. The first visual output may be output in a forward direction. The first visual output may be output from a forward surface of the device. The first visual output may be output from a middle of a forward portion of the device. The first visual output may be output below an optical element of the device. The first visual output may be output based on a user display setting. The first visual output may be configured to provide ownership information. The first visual output may comprise non-textual information. The first visual output may comprise a static symbol, design, or the like.

In various embodiments, the device may output a second visual output on a second display (step 406). The second display may be similar to any other second display disclosed herein. The second visual output may be output in an upward direction. The second visual output may be output from a top surface of the device. The second visual output may be output above an optical element of the device. The second visual output may be configured to provide status information.

In various embodiments, the device may receive an activation event (step 408). The activation event may be received, or detected from, an event interface of the device. The device may perform operations in response to receiving the activation event. For example, the device may begin recording images, end recording images, establish two-way communications, and/or the like.

In various embodiments, the device may control the first visual output on the first display (step 410). The device may control the first visual output in response to receiving the activation event. The device may control the first visual output by varying the first visual output. For example, the device may vary the first visual output by changing a property of the first visual output, such as a color, a motion, a symbol, a design, and/or the like. As a further example, the device may vary the first visual output by providing different or additional information in the first visual output. For example, varying the first visual output may comprise providing or indicating recording status information through the first visual output. In that regard, the first visual output may provide ownership information and may provide or indicate recording status information.

In various embodiments, the device may further control the second visual output in response to receiving the activation event. The device may control the second visual output by varying the second visual output. For example, the device may vary the second visual output by changing a property of the second visual output. As a further example, the device may vary the second visual output by providing different or additional information in the second visual output. For example, varying the second visual output may comprise providing or indicating recording status information through the second visual output. In that regard, the first visual output may provide status information and may provide or indicate recording status information.

In various embodiments, varying the first visual output may be different from varying the second visual output. For example, varying the first visual output may comprise changing a static visual output to a different visual output. As a further example, varying the second visual output may comprise adding information to a same visual output in the second visual output.

In various embodiments, varying the first visual output may be based on a user display setting. In that regard, different types of activation events may be associated with different variations of the first visual output.

In various embodiments, the first visual output may indicate the recording status in a first visual format, the second visual output may indicate the recording status in a second visual format, and the first visual format may be different from the second visual format. The first visual format may comprise a non-textual display. The first visual format may comprise a change in a motion, a color, and/or the like.

In various embodiments, the device may further perform any other operation in response to receiving the activation event. For example, the device may provide an audio output via an audio output module. The audio output may be defined based on a user display setting. In that regard, different types of activation events may be associated with different types of audio outputs.

In various embodiments, a recording device is disclosed. The recording device may comprise a body. The body may comprise a front surface opposite a rear surface, a top surface opposite a bottom surface, and a first side surface opposite a second side surface. The recording device may comprise a first display disposed on the front surface of the body. The first display may be configured to provide a first visual output. The recording device may comprise a second display disposed on the top surface of the body. The second display may be configured to provide a second visual output. The first visual output may be different from the second visual output.

In various embodiments of the above recording device, the first display may comprise a dot-matrix display, and the second display may comprise an LED display. The first visual output may comprise ownership information, and the second visual output may comprise status information. The first display may comprise a first resolution, the second display may comprise a second resolution, and the first resolution may be a lower resolution than the second resolution. The first display may comprise a first density of light emitting elements, the second display may comprise a second density of light emitting elements, and the first density of light emitting elements may be less than the second density of light emitting elements.

In various embodiments of the above recording device, the first display may be a user programmable display, and the first visual output may be based on a user display setting. The recording device may further comprise a mount coupled to the rear surface of the body, and the user display setting may be associated with the mount. The user display setting may define an event-based visual output. The user display setting may define at least one of a symbol, a color, or a motion.

In various embodiments of the above recording device, the first display may comprise a simple display, and the second display may comprise a complex display. The first display and the second display may comprise non-video displays. The first display may comprise a color display, and the second display may comprise a black and white display. The first display may be a user programmable display, and the first visual output may be based on a user display setting. The recording device may further comprise a mount coupled to the rear surface of the body, and the user display setting may be associated with the mount. The mount may comprise a mount identifier, and the user display setting may be associated with the mount identifier.

In various embodiments of the above recording device, the first display may comprise a first resolution, the second display may comprise a second resolution, and the first resolution may be a lower resolution than the second resolution. The first display may be configured to consume a first amount of power during an operating time period, the second display may be configured to consume a second amount of power during the operating time period, and the first amount of power may be less than the second amount of power.

In various embodiments of the above recording device, the first display may define a first surface area of the front surface, and the first surface area may be less than 50% of a total surface area of the front surface. The second display may define a second surface area of the top surface, and the second surface area may be greater than 50% of a total surface area of the top surface. The first display may define a first height and a first width, the second display may define a second height and a second width, and the first height may be different from the second height and the first width may be different from the second width. The first height may be greater than the second height, and the first width may be less than the second width.

In various embodiments of the above recording device, the first visual output may comprise ownership information, and the second visual output may comprise status information. The first visual output may further comprise status information. The first visual output may be configured to vary based on a recording status.

In various embodiments, a method is disclosed. The method may comprise one or more steps including: providing, by a recording device, electrical power to one or more components of the recording device; outputting, by a first display of the recording device, a first visual output, wherein the first display is disposed on a front surface of the recording device; and outputting, by a second display of the recording device, a second visual output, wherein the second display is disposed on a top surface of the recording device. The first visual output may be different from the second visual output.

In various embodiments of the above method, the first display may be disposed below an optical element of the recording device, and the second display may be disposed above the optical element. The first visual output may be output in a forward direction, and the second visual output may be output in an upward direction. The first visual output may be configured to provide ownership information, and the second visual output may be configured to provide status information. The first visual output may comprise non-textual information. The method may further comprise the step of determining a user display setting, wherein the outputting the first visual output is based on the user display setting.

In various embodiments, a recording device is disclosed. The recording device may comprise a body. The body may comprise a front surface opposite a rear surface, a top surface opposite a bottom surface, and a first side surface opposite a second side surface. The recording device may comprise a simple display disposed on the front surface. The simple display may be configured to provide ownership information. The recording device may comprise a complex display disposed on the top surface. The complex display may be configured to provide status information.

In various embodiments of the above recording device, the simple display may comprise a dot-matrix display, and the complex display may comprise an LED display. The simple display may define a first surface area of the front surface, and the first surface area may be less than 50% of a total surface area of the front surface. The complex display may define a second surface area of the top surface, and the second surface area may be greater than 50% of a total surface area of the top surface. The simple display may define a first height and a first width, the complex display may define a second height and a second width, the first height may be greater than the second height, and the first width may be less than the second width.

In various embodiments, a recording device is disclosed. The recording device may comprise a body comprising a forward surface opposite a rearward surface. The recording device may comprise a first display disposed on the forward surface. The first display may be configured to provide a first visual output. The recording device may comprise a second display disposed on the forward surface. The second display may be configured to provide a second visual output.

In various embodiments of the above recording device, the forward surface may define a front end and a top end of the body and a first portion of a bottom end, a first side end, and a second side end of the body. The rearward surface may define a rear end of the body and a second portion of the bottom end, the first side end, and the second side end of the body. The first display may be disposed on the forward surface at the front end of the body, and the second display may be disposed on the forward surface at the top end of the body. The rearward surface may comprise a static surface, and the forward surface may comprise an at least partially translatable surface.

In various embodiments of the above recording device, the forward surface may comprise a first forward surface and a second forward surface, the first forward surface may comprise an at least partially translatable surface, and the second forward surface may comprise a static surface. The first display and the second display may be disposed on the first forward surface. The first forward surface may comprise an extended region that extends downward towards a bottom end of the body, and the second forward surface may comprise a recess configured to receive the extended region.

The recess may comprise a U shape. The first display may be disposed on the extended region. The extended region may comprise a translatable surface. The first display may be disposed on the translatable surface. The recording device may further comprise an event interface positioned proximate the first display. The first display may comprise the event interface. The event interface may be positioned beneath the first display. An activation of the event interface may be configured to vary the first visual output provided by the first display.

In various embodiments of the above recording device, the recording device may further comprise an optical element disposed on the forward surface, and the optical element may be positioned between the first display and the second display. The optical element may comprise an optical axis, and the first display may be configured to provide the first visual output along the optical axis. The first display may be configured to provide the first visual output in a forward direction, and the second display may be configured to provide the second visual output in an upward direction.

In various embodiments of the above recording device, the second display may be disposed orthogonal to the first display. The first display may comprise a dot-matrix display, the second display may comprise an LED display, the first visual output may be configured to comprise ownership information, and the second visual output may be configured to comprise status information.

In various embodiments, a method is disclosed. The method may comprise one or more steps including outputting, by a first display of a recording device, a first visual output, wherein the first visual output comprises ownership information; outputting, by a second display of the recording device, a second visual output, wherein the second visual output comprises status information; receiving, by the recording device, an activation event; and changing, by the recording device, the first visual output in response to receiving the activation event.

In various embodiments of the above method, the first visual output may be output in a forward direction, and the second visual output may be output in an upward direction. The first visual output may comprise non-textual information, and the second visual output may comprise textual information. The step of changing the first visual output may comprise varying a property of the first visual output, and the property may comprise at least one of a color, a motion, or a design. The step of changing the first visual output may comprise changing a static visual output to a different visual output. The step of changing the first visual output may comprise adding information to the first visual output. The step of changing the first visual output may comprise varying the first visual output to indicate recording status information. In response to the step of changing the first visual output, the first visual output may provide the ownership information and recording status information.

In various embodiments of the above method, the method may further comprise the step of changing, by the recording device, the second visual output in response to receiving the activation event. The step of changing the second visual output may comprise varying the second visual output to indicate recording status information. In response to the step of changing the second visual output, the second visual output may provide the status information and recording status information. The step of changing the first visual output may be different from the step of changing the second visual output. The step of changing the first visual output may indicate a recording status, and the step of changing the second visual output may indicate the recording status.

The first visual output may indicate the recording status in a first visual format, the second visual output may indicate the recording status in a second visual format, and the first visual format may be different from the second visual format. The first visual format may comprise a non-textual display. The first visual format may comprise a change in at least one of motion or color. The step of changing the first visual output and the step of changing the second visual output may be based on a user display setting.

In various embodiments of the above method, the step of changing the first visual output may be based on a user display setting. The method may further comprise the step of outputting, by the recording device, an audio output in response to receiving the activation event. The step of changing the first visual output and the step of outputting the audio output may be based on a user display setting.

In various embodiments, and with reference to FIG. 5, an exemplary computer-based system 501 is disclosed. Computer-based system 501 may be appropriate for use in accordance with embodiments of the present disclosure. The accompanying description of computer-based system 501 may be applicable to servers, personal computers, mobile phones, smart phones, tablet computers, embedded computing devices, and other currently available or yet-to-be-developed devices that may be used in accordance with embodiments of the present disclosure.

Computer-based system 501 may include a processor 502 and a system memory 504 connected by a communication bus 506. Depending on the exact configuration and type of computer-based system, system memory 504 may be volatile or nonvolatile memory, such as read only memory (“ROM”), random access memory (“RAM”), EEPROM, flash memory, or other memory technology. Those of ordinary skill in the art and others will recognize that system memory 504 typically stores data and/or program modules that are immediately accessible to and/or currently being operated on by processor 502. In this regard, processor 502 may serve as a computational center of computer-based system 501 by supporting the execution of instructions. Processor 502 may comprise one or more processing units, as discussed further herein. System memory 504 may comprise one or more memory units, as discussed further herein.

Computer-based system 501 may include a network interface 510 comprising one or more components for communicating with other devices and systems over a network. Embodiments of the present disclosure may access basic services that utilize network interface 510 to perform communications using common network protocols. Network interface 510 may comprise a communications unit, as discussed further herein.

Computer-based system 501 may also include a storage medium 508. However, services may be accessed using a computer-based system that does not include means for persisting data to a local storage medium. Therefore, storage medium 508 depicted in FIG. 5 is optional. Storage medium 508 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like. Storage medium 508 may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data. In this regard, system memory 504 and storage medium 508 depicted in FIG. 5 are examples of computer-readable media.

For ease of illustration and because it is not important for an understanding of the claimed subject matter, FIG. 5 does not show some of the typical components of many computer-based systems. In this regard, computer-based system 501 may include input devices, such as a keyboard, keypad, mouse, trackball, microphone, video camera, touchpad, touchscreen, electronic pen, stylus, and/or any other input device described herein. Such input devices may be coupled to computer-based system 501 by wired or wireless connections including RF, infrared, serial, parallel, BLUETOOTH®, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computer-based system 501 (e.g., a client device), or can be integral components of computer-based system 501. In some embodiments, multiple input devices may be combined into a single, multifunction input device (e.g., a video camera with an integrated microphone).

Computer-based system 501 may also include output devices such as a display, speakers, printer, and/or any other output device described herein. The output devices may include video output devices such as a display or touchscreen. The output devices also may include audio output devices such as external speakers or earphones. The output devices can be separate from and communicatively coupled to computer-based system 501, or can be integral components of computer-based system 501. Input functionality and output functionality may be integrated into the same input/output device (e.g., a touchscreen). Any suitable input device, output device, or combined input/output device either currently known or developed in the future may be used with described systems.

In various embodiments, a “processing unit” as described herein may comprise any suitable hardware and/or software-based processing component. For example, a processing unit may comprise one or more of a processing circuit, a processor, an application specific integrated circuit (ASIC), a controller, a microcontroller, a microprocessor, a programmable logic device, logic circuitry, and/or the like.

In various embodiments, a “communications unit” as described herein may comprise any suitable hardware and/or software components capable of enabling the transmission and/or reception of data. A communications unit may enable electronic communications between devices and systems. A communications unit may enable communications over a network. Examples of a communications unit may include a modem, a network interface (such as an Ethernet card), a communications port, etc. Data may be transferred via a communications unit in the form of signals which may be electronic, electromagnetic, optical, or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., FireWire), Integrated Services for Digital Network (ISDN), a digital subscriber line (DSL), an 502.11a/b/g/n/ac signal (e.g., Wi-Fi), a wireless communications protocol using short wavelength UHF radio waves and defined at least in part by IEEE 502.15.1 (e.g., the BLUETOOTH® protocol maintained by Bluetooth Special Interest Group), a wireless communications protocol defined at least in part by IEEE 502.15.4 (e.g., the ZigBee® protocol maintained by the ZigBee alliance), a cellular protocol, an infrared protocol, an optical protocol, or any other protocol capable of transmitting information via a wired or wireless connection.

Two or more of the system components may be in electronic communication via a network. As used herein, the term “network” may further include any cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

Electronic communications between the systems and devices may be unsecure. A network may be unsecure. Electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, a “memory” or “memory unit” as discussed herein may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Any database discussed herein may include relational, hierarchical, graphical, distributed ledger, blockchain, object-oriented structure, and/or any other database configurations, unless otherwise specified. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

Any database, system, device, server, or other components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

In various embodiments, an “input device” as discussed herein may comprise hardware and/or software used to provide data, inputs, control signals, and the like to a computer-based system, software application, etc. For example, an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, an “output device” as discussed herein may comprise hardware and/or software configured to convert information into a human-accessible form, for display, projection, or physical reproduction. For example, an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a printer (e.g., dot matrix printer, inkjet printer, laser printer, 3D printer, wide-format printer, etc.), a braille reader, a composite device (e.g., a device having a plurality of different forms of output), and/or any other output device.

In various embodiments, “satisfy,” “meet,” “match,” “associated with,” or similar phrases used herein may include an identical match, a partial match, meeting certain criteria, matching a subset of data, a correlation, satisfying certain criteria, a correspondence, an association, an algorithmic relationship, and/or the like. Similarly, as used herein, “authenticate,” “verify,” “validate,” or similar terms may include an exact authentication, verification, or validation; a partial authentication, verification, or validation; authenticating, verifying, or validating a subset of data; satisfying certain criteria; an association; an algorithmic relationship; and/or the like.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A recording device comprising:
a body comprising:
a front surface opposite a rear surface;
a top surface opposite a bottom surface; and
a first side surface opposite a second side surface;
a first display disposed on the front surface, wherein the first display is configured to provide a first visual output; and
a second display disposed on the top surface, wherein the second display is configured to provide a second visual output, and wherein the first visual output is different from the second visual output.

2. The recording device of claim 1, wherein the first display comprises a dot-matrix display, and wherein the second display comprises an LED display.

3. The recording device of claim 1, wherein the first visual output comprises ownership information, and wherein the second visual output comprises status information.

4. The recording device of claim 1, wherein the first display is a user programmable display, and wherein the first visual output is based on a user display setting.

5. The recording device of claim 4, further comprising a mount coupled to the rear surface of the body, wherein the user display setting is associated with the mount.

6. The recording device of claim 4, wherein the user display setting defines an event-based visual output.

7. The recording device of claim 4, wherein the user display setting defines at least one of a symbol, a color, or a motion.

8. The recording device of claim 1, wherein the first display comprises a first resolution, wherein the second display comprises a second resolution, and wherein the first resolution is a lower resolution than the second resolution.

9. The recording device of claim 1, wherein the first display comprises a first density of light emitting elements, wherein the second display comprises a second density of light emitting elements, and wherein the first density of light emitting elements is less than the second density of light emitting elements.

10. A method comprising:
providing, by a recording device, electrical power to one or more components of the recording device;
outputting, by a first display of the recording device, a first visual output, wherein the first display is disposed on a front surface of the recording device; and
outputting, by a second display of the recording device, a second visual output, wherein the second display is disposed on a top surface of the recording device, and wherein the first visual output is different from the second visual output.

11. The method of claim 10, wherein the first display is disposed below an optical element of the recording device, and wherein the second display is disposed above the optical element.

12. The method of claim 10, wherein the first visual output is output in a forward direction, and wherein the second visual output is output in an upward direction.

13. The method of claim 10, wherein the first visual output is configured to provide ownership information, and wherein the second visual output is configured to provide status information.

14. The method of claim 10, wherein the first visual output comprises non-textual information.

15. The method of claim 10, further comprising determining a user display setting, wherein the outputting the first visual output is based on the user display setting.

16. A recording device comprising:
a body comprising:
a front surface opposite a rear surface;
a top surface opposite a bottom surface; and
a first side surface opposite a second side surface;
a simple display disposed on the front surface, wherein the simple display is configured to provide ownership information; and
a complex display disposed on the top surface, wherein the complex display is configured to provide status information.

17. The recording device of claim 16, wherein the simple display comprises a dot-matrix display, and wherein the complex display comprises an LED display.

18. The recording device of claim 16, wherein the simple display defines a first surface area of the front surface, and wherein the first surface area is less than 50% of a total surface area of the front surface.

19. The recording device of claim 16, wherein the complex display defines a second surface area of the top surface, and wherein the second surface area is greater than 50% of a total surface area of the top surface.

20. The recording device of claim 16, wherein the simple display defines a first height and a first width, wherein the complex display defines a second height and a second width, wherein the first height is greater than the second height, and wherein the first width is less than the second width.
